(19) United States
(12) Patent Application Publication
(10) Pub. No.: US 2015/0019348 A1
(43) Pub. Date: Jan. 15, 2015

(54) DETERMINING WHETHER TO SEND A CALL-OUT TO A BIDDER IN AN ONLINE CONTENT AUCTION

(71) Applicant: Google Inc., Mountain View, CA (US)

(72) Inventors: Matthew Young-Lai, Kitchener (CA); Peter L. Milley, Kitchener (CA); Seyed Hossein Bokharaei, Kitchener (CA); Julian Z. Suszko, Kitchener (CA); Aaron Voelker, Kitchener (CA)

(21) Appl. No.: 13/937,454

(22) Filed: Jul. 9, 2013

(51) Int. Cl. G06Q 30/02

(52) U.S. Cl. CPC G06Q 30/0275
USPC 705/14.71

(57) ABSTRACT

An example process includes: obtaining information about call-outs from at least one bidder of an online content auction, where the information spans a time period and the information identifies which call-outs, within the time period, did not result in a response; identifying, based on the information, one or more features that are common to call-outs that did not result in at least a threshold number of responses from the at least one bidder; generating a model for the at least one bidder that predicts whether the at least one bidder will respond to a call-out associated with the one or more features; using the model to determine a percentage of additional call-outs having the one or more features to send to the at least one bidder; and sending the percentage of additional call-outs to the at least one bidder.

### TECHNICAL FIELD

This disclosure relates generally to determining whether to send a call-out to a bidder in an online content auction.

### BACKGROUND

The Internet provides access to a wide variety of resources. For example, video, audio, and Web pages are accessible over the Internet. These resources present opportunities for other content (e.g., advertising or non-advertising content, such as audio, video, or the like) to be provided with the resources. For example, a Web page can include slots in which content can be presented. Similarly, such slots can be part of television programming.

Slots can be allocated to content providers (e.g., advertisers). In some systems, a network can be used to allocate content to the slots based, e.g., based on various factors relating to the content and the context in which it is to be presented. For example, the content can be allocated based, in part, on keywords input into a system, such as a search engine, or on contextually derived keywords. An online content auction can be performed for the right to present advertising in a slot. In the auction, content sponsors provide bids specifying amounts that the content sponsors are willing to pay for presentation of their content. Typically, the one or more winning bidders are given the right to present content.

An entity that brokers the online content auction may provide call-outs to known bidders. A call-out may identify a slot up for auction, along with information about how content may be presented if a bidder wins the auction. In response to the call-out, the bidder may respond with content (e.g., advertising) and a bid for the slot. Alternatively, the bidder may elect not to respond to the call-out.

### SUMMARY

An example process for determining whether to send a call-out to a bidder in an online content auction includes: obtaining information about call-outs from at least one bidder of an online content auction, where the information spans a time period and the information identifies which call-outs, within the time period, did not result in a response; using one or more processing devices to identify, based on the information, one or more features that are common to call-outs that did not result in at least a threshold number of responses from the at least one bidder; generating, and storing in memory on at least one server, a model for the at least one bidder that predicts whether the at least one bidder will respond to a call-out associated with the one or more features; using the model to determine a percentage of additional call-outs having the one or more features to send to the at least one bidder; and sending the percentage of additional call-outs to the at least one bidder. The example process may include one or more of the following features, either alone or in combination with other features.

The example process may include obtaining information about the additional call-outs, where the information identifies which additional call-outs resulted in at least one response; using the one or more processing devices to identify, based on the information about the additional call-outs, one or more features that are common to the additional call-outs that resulted in at least one response; and modifying the model to take into account that the one or more features that are common to the additional call-outs resulted in at least one response. Modifying the model may include removing, from the model, the one or more features that are common to the additional call-outs that resulted in at least one response.

The model may reside on multiple servers throughout a geographic area. The at least one server may be within a specified geographic proximity of the at least one bidder within the geographic area. The example process may include modifying the model stored in the at least one server and, after an elapse of the time period following the modifying, modifying models stored in others of the multiple servers.

The threshold number of responses may be at least one response and the percentage of additional call-outs may be non-zero. The at least one bidder may be a single bidder. The at least one bidder may include multiple bidders having one or more attributes in common.

The one or more features may include one or more of the following: a country in which content is to be presented, a geographic area in which content is to be presented, a size of a slot in which content is to be presented, a page on which content is to be presented, a language of the page on which content is to be presented, a type of device on which content is to be presented, a media type of a slot in which content is to be presented, information about a publisher that is to present the content, a product category relating to a page in which the content is to be presented, a branding type associated with the content, and a network carrier over which the content is to be presented.

Identifying the one or more features may include examining the information for different combinations of the one or more features to identify which combinations of the one or more features correspond to call-outs that did not result in a threshold number of responses from the at least one bidder.

Two or more of the features described in this disclosure/specification, including this summary section, can be combined to form implementations not specifically described herein.

The systems and techniques described herein, or portions thereof, can be implemented as a computer program product that includes instructions that are stored on one or more non-transitory machine-readable storage media, and that are executable on one or more processing devices. The systems and techniques described herein, or portions thereof, can be implemented as an apparatus, method, or electronic system that can include one or more processing devices and memory to store executable instructions to implement the stated operations.

The details of one or more implementations are set forth in the accompanying drawings and the description below. Other features and advantages will be apparent from the description and drawings, and from the claims.

### DESCRIPTION OF THE DRAWINGS

FIG. 1 is a block diagram of an example network environment on which the example processes described herein can be implemented.

FIG. 2 is an example of a process for determining whether to send a call-out to a bidder in an online content auction.

FIG. 3 is an example of a computer system on which the processes described herein may be implemented.

Like reference symbols in the various drawings indicate like elements.

### DETAILED DESCRIPTION

Content, such as advertising, may be provided to network users based on various factors, e.g., on demographics, keywords, language, and interests. For example, advertising (an “ad”) may be associated with one or more keywords that are stored as metadata along with the ad. A search engine, which operates on the network, may receive input from a user. The input may include one or more of the keywords. A content management system, which serves ads, may receive the keywords from the search engine, identify the ad as being associated with one or more of the keywords, and output the ad to the user, along with content that satisfies the initial search request. The content and the ad are displayed on a computing device. When displayed, the ad is incorporated into an appropriate slot on the results page. The user may select the ad by clicking-on the ad. In response to selection, typically a hyperlink associated with the ad directs the user to another Web page. For example, if the ad is for ABC Travel Company, the Web page to which the user is directed may be the home page for ABC Travel Company. This activity is known as click-through. In this context, a “click” is not limited to a mouse click, but rather may include a touch, a programmatic selection, or any other interaction by which the ad may be selected.

A content auction may be run to determine which content is to be output in response to an input. In the auction, content providers may bid on specific slots or information associated with those slots, such as keywords. The content provider may bid in the content auction, e.g., on a cost-per-click (CPC) basis or a cost per thousand impressions (CPM) basis. The content provider's bid is an amount (e.g., a maximum amount) that the provider will pay for users clicking on their content or for displaying their content to users. So, for example, if a content provider bids five cents per click, then the content provider may pay five cents each time their content is clicked-on by a user, depending upon the type of the auction. In another example, a bidder pays each time one thousand impressions of its content are displayed. In other examples, payment may be on the basis of other actions (e.g., an amount of time spent on a landing page, a purchase, and so forth).

Bidding in a content auction typically takes place against other content providers. The content auction is run (e.g., by the content management system) to determine which content to serve along with search results or any other requested content. Typically, the one or more winners of the content auction, and their relative rank, may be decided based on bidding price or other factors. In this context, a page includes any display area, such as a Web page, a continuously scrollable screen, and so forth. In some examples, the top-ranked winners of the auction will be accorded the most preferred slot(s) on the page, while others will be accorded slots that are less preferred.

In some implementations of an online content auction, the auction broker (e.g., a content management system, including associated hardware and/or computer programs) may provide call-outs to known bidders. In this example, a bidder may be an actual content provider or an agent that acts on behalf of many content providers. Call-outs may be sent to bidders that have been identified, based on information about past bidding activity, as bidders who may be interested in bidding on a slot or other feature at auction. For example, a call-out may identify a slot up for auction, along with information about how content may be presented if a bidder wins the auction. For example, a call-out may specify the dimensions of the slot and the type of content (e.g., images, video, audio, etc.) that may be presented in the slot. The call-out may also specify other information relating to distribution of content in the slot including, for example, but not limited to: the identify of the Web page on which the content is to be presented, the subject matter of the Web page, a minimum CPM or CPC for the slot, the identity of the publisher of the Web page on which the content is to be presented, and so forth. In some implementations, call-outs may be for bidding on keywords or other features of an auction.

A bidder that receives a call-out may respond with content (e.g., advertising) and a bid for the slot. Alternatively, the bidder may elect not to respond to the call-out. The auction broker may maintain a record of call-outs sent to a bidder over a time period (e.g., a day, a week, a month, a year, or any appropriate time period), information associated with those call-outs, and whether the call-outs resulted in a response or no response. In an example implementation, in a case where the call-out did not result in a response, the auction broker identifies, based on the information, one or more features that are common to call-outs that did not result in any response. In another example implementation, the auction broker identifies, based on the information, one or more features that are common to call-outs that did not result in at least a threshold number of responses.

Examples of the one or more features include, but are not limited to, one or more of the following: a country in which content for a call-out was to be presented, a geographic area in which the content was to be presented, a size of a slot in which the content was to be presented, a resource (e.g., Web page) on which the content was to be presented, a language of the resource or page on which the content was to be presented, a type of device on which the content was to be presented, a media type of a slot in which the content was to be presented, information about a publisher (e.g., a resource or Web page owner) that was to present the content, a product category relating to the resource or page, a branding type associated with the content, a network carrier over which the content was to be presented, and so forth.

The auction broker uses at least some of the above information to generate a model to predict whether the bidder will respond to a future call-out. For example, a machine-learning process may be used to generate the model by identifying which combination(s) of one or more features previously resulted in a response to a call-out. The model is then used to predict whether a future call-out will result in a response. In an example implementation, the auction broker determines if the future call-out, and/or elements (hardware and/or software) associated with distributing content for the future call-out, are associated with one or more of the foregoing features. If so, the future call-out may, or may not, be sent to the bidder, as described below.

More specifically, in some implementations, the auction broker sends, to the bidder, a percentage of call-outs that were predicted by the model not to generate a response. The percentage may be set in the model for a particular bidder. In some implementations, the percentage may be based on other factors relating to the bidders or the call-outs, such as the overall activity of a bidder, the number of call-outs that did not receive a response, prices the bidder is offering, and so forth. The percentage of the call-outs that were predicted by the model not to generate a response may be sent in order to gauge if the bidder has changed their bidding strategy. For example, if a call-out that was predicted not to generate a response from the bidder actually does generate a response, then the model previously generated may be modified to take this information into account. For example, the feature(s) associated with that call-out may be removed from the model so that the model no longer identifies those features as being call-out features that will not elicit a response from a bidder.

In some implementations, the model is stored in one or more servers that are located in a same geographic area as the bidder. The location of the bidder and the one or more servers may be identified, e.g., by their Internet sub-net addresses or by other mechanisms. In some implementations, only the models in the local server(s) are modified initially. Models maintained outside the local geographic area are not updated until new data is obtained about the bidder for the time period (e.g., they are not updated until the next day). This feature can be advantageous because it reduces the need to synchronize the model among non-local servers, and therefore allows local servers to provide feedback more quickly.

The example process described herein can be implemented in any appropriate network environment, with any appropriate devices and computing equipment. An example of such an environment is described below.

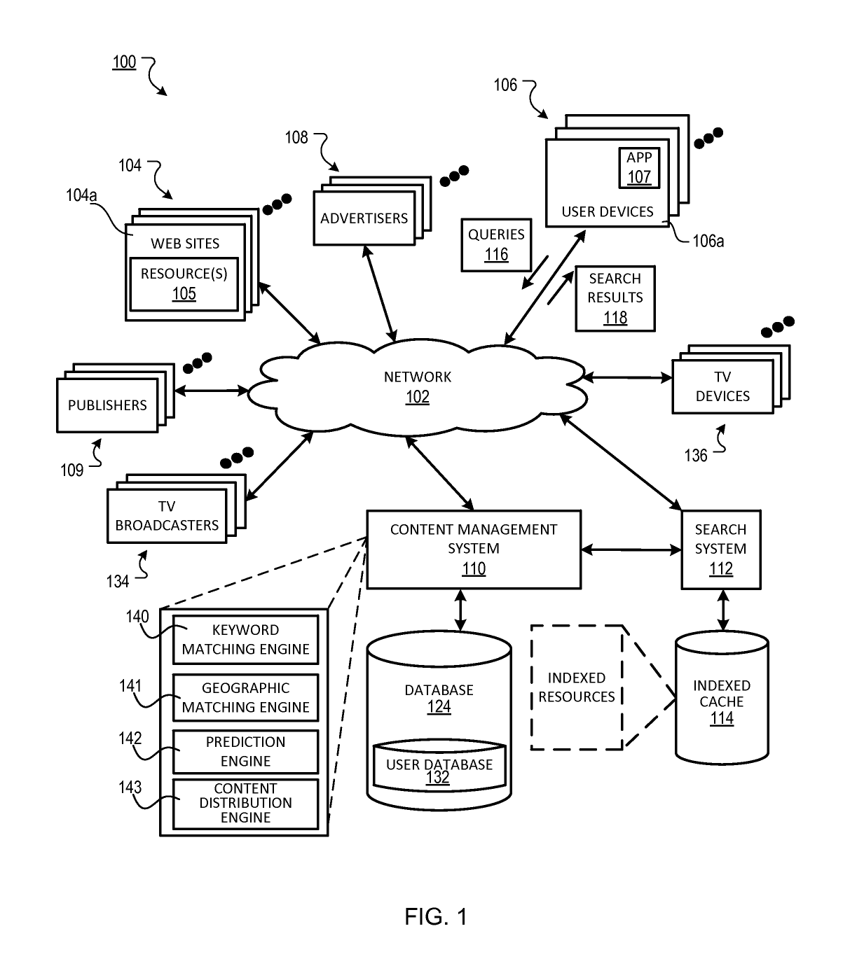

FIG. 1 is a block diagram of an example environment 100 for providing content to a user of a user device and for regulating call-outs as described herein. The example environment 100 includes a network 102.

Network 102 can represent a communications network that can allow devices, such as a user device 106a, to communicate with entities on the network through a communication interface (not shown), which can include digital signal processing circuitry. Network 102 can include one or more networks. The network(s) can provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication can occur through a radio-frequency transceiver. In addition, short-range communication can occur, such as using a Bluetooth, WiFi, or other such transceiver.

Network 102 connects various entities, such as Web sites 104, user devices 106, content providers (e.g., advertisers 108), online publishers 109, and a content management system 110. In this regard, example environment 100 can include many thousands of Web sites 104, user devices 106, and content providers (e.g., advertisers 108). Entities connected to network 102 include and/or connect through one or more servers. Each such server can be one or more of various forms of servers, such as a Web server, an application server, a proxy server, a network server, or a server farm. Each server can include one or more processing devices, memory, and a storage system.

In FIG. 1, Web sites 104 can include one or more resources 105 associated with a domain name and hosted by one or more servers. An example Web site 104a is a collection of Web pages formatted in hypertext markup language (HTML) that can contain text, images, multimedia content, and programming elements, such as scripts. Each Web site 104 can be maintained by a publisher 109, which is an entity that controls, manages and/or owns the Web site 104.

A resource 105 can be any appropriate data that can be provided over network 102. A resource 105 can be identified by a resource address that is associated with the resource 105. Resources 105 can include HTML pages, word processing documents, portable document format (PDF) documents, images, video, and news feed sources, to name a few. Resources 105 can include content, such as words, phrases, images and sounds, that can include embedded information (such as meta-information hyperlinks) and/or embedded instructions (such as JavaScript scripts).

To facilitate searching of resources 105, environment 100 can include a search system 112 that identifies the resources 105 by crawling and indexing the resources 105 provided by the content publishers on the Web sites 104. Data about the resources 105 can be indexed based on the resource 105 to which the data corresponds. The indexed and, optionally, cached copies of the resources 105 can be stored in an indexed cache 114.

An example user device 106a is an electronic device that is under control of a user and that is capable of requesting and receiving resources over the network 102. A user device can include one or more processing devices, and can be, or include, a mobile telephone (e.g., a smartphone), a laptop computer, a handheld computer, an interactive or so-called “smart” television or set-top box, a tablet computer, a network appliance, a camera, an enhanced general packet radio service (EGPRS) mobile phone, a media player, a navigation device, an email device, a game console, or a combination of any two or more of these data processing devices or other data processing devices. In some implementations, the user device can be included as part of a motor vehicle (e.g., an automobile, an emergency vehicle (e.g., fire truck, ambulance), a bus).

User device 106a typically stores one or more user applications, such as a Web browser, to facilitate the sending and receiving of data over the network 102. A user device 106a that is mobile (or simply, “mobile device”), such as a smartphone or a table computer, can include an application (“app”) 107 that allows the user to conduct a network (e.g., Web) search. User devices 106 can also be equipped with software to communicate with a GPS system, thereby enabling the GPS system to locate the mobile device.

User device 106a can request resources 105 from a Web site 104a. In turn, data representing the resource 105 can be provided to the user device 106a for presentation by the user device 106a. User devices 106 can also submit search queries 116 to the search system 112 over the network 102. A request for a resource 105 or a search query 116 sent from a user device 106 can include an identifier, such as a cookie, identifying the user of the user device.

In response to a search query 116, the search system 112 can access the indexed cache 114 to identify resources 105 that are relevant to the search query 116. The search system 112 identifies the resources 105 in the form of search results 118 and returns the search results 118 to a user device 106 in search results pages. A search result 118 can include data generated by the search system 112 that identifies a resource 105 that is responsive to a particular search query 116, and includes a link to the resource 105. An example search result 118 can include a Web page title, a snippet of text or a portion of an image obtained from the Web page, and the URL (Unified Resource Location) of the Web page.

Content management system 110 can be used for selecting and providing content in response to requests for content. Content management system 110 also can, with appropriate user permission, update database 124 based on activity of a user. The user may enable and/or disable the storing of such information. In this regard, with appropriate user permission, the database 124 can store a profile for the user which includes, for example, information about past user activities, such as visits to a place or event, past requests for resources 105, past search queries 116, other requests for content, Web sites visited, or interactions with content. User interests may also be stored in the profile and, in some examples, may be determined from the information about past user activities. In some implementations, the information in database 124 can be derived, for example, from one or more of a query log, an advertisement log, or requests for content. The database 124 can include, for each entry, a cookie identifying the user, a timestamp, an IP (Internet Protocol) address associated with a requesting user device 106, a type of usage, and details associated with the usage.

Content management system 110 may include a keyword matching engine 140 to compare query keywords to content keywords and to generate a keyword matching score indicative of how well the query keywords match the content keywords. In an example, the keyword matching score is equal, or proportional, to a sum of a number of matches of words in the input query to words associated with the content. Content management system 110 may include a geographic (or “geo-”) matching engine 141 to compare geographic information (e.g., numerical values for place names) obtained from words in input queries to geographic information associated with content. Content management system 110 may also include other engines (not shown) for matching input demographics to desired demographics of an ad campaign, for identifying Web pages or other distribution mechanisms based on content, and so forth.

When a resource 105 or search results 118 are requested by a user device 106, content management system 110 can receive a request for content to be provided with the resource 105 or search results 118. The request for content can include characteristics of one or more “slots” that are defined for the requested resource 105 or search results page. For example, the data representing the resource 105 can include data specifying a portion of the resource 105 or a portion of a user display, such as a presentation location of a pop-up window or a slot of a third-party content site or Web page, in which content can be presented. An example slot is an ad slot. Search results pages can also include one or more slots in which other content items (e.g., ads) can be presented.

Information about slots can be provided to content management system 110. For example, a reference (e.g., URL) to the resource for which the slot is defined, a size of the slot, and/or media types that are available for presentation in the slot can be provided to the content management system 110. Similarly, keywords associated with a requested resource or a search query 116 for which search results are requested can also be provided to the content management system 110 to facilitate identification of content that is relevant to the resource or search query 116.

Based at least in part on data generated from and/or included in the request, content management system 110 can select content that is eligible to be provided in response to the request (“eligible content items”). Content management system 110 can select the eligible content items that are to be provided for presentation in slots of a resource 105 or search results page 118 based, at least in part, on results of an auction, such as a second price auction. For example, for eligible content items, content management system 110 can receive bids from content providers (e.g., advertisers 108) and allocate the content to slots, based at least in part on the received bids (e.g., based on the highest bidders at the conclusion of the auction). The bids are amounts that the content providers are willing to pay for presentation (or selection) of their content with a resource 105 or search results page 118. For example, a bid can specify an amount that a content provider is willing to pay for each 1000 impressions (i.e., presentations) of the content item, referred to as a CPM bid. Alternatively, the bid can specify an amount that the content provider is willing to pay for a selection (i.e., a click-through) of the content item or a conversion following selection of the content item. This is referred to as cost-per-click (CPC). The selected content item can be determined based on the bids alone, or based on the bids of each bidder being multiplied by one or more factors, such as quality scores derived from content performance, landing page scores, and/or other factors.

In some implementations, TV (Television) broadcasters 134 produce and present television content on TV user devices 136, where the television content can be organized into one or more channels. The TV broadcasters 134 can include, along with the television content, one or more content slots in which other content (e.g., advertisements) can be presented. For example, a TV network can sell slots of advertising to advertisers in television programs that they broadcast. Some or all of the content slots can be described in terms of user audiences which represent typical users who watch content with which a respective content slot is associated. Content providers can bid, in an auction (as described above), on a content slot that is associated with keywords for particular television content.

Content management system 110 may include a prediction engine 142. Prediction engine 142 may implement all or part of the example processes described herein for determining whether to send a call-out to a bidder in an online content auction. Content selected for output may be distributed by content distribution engine 143, which is also part of the content management system.

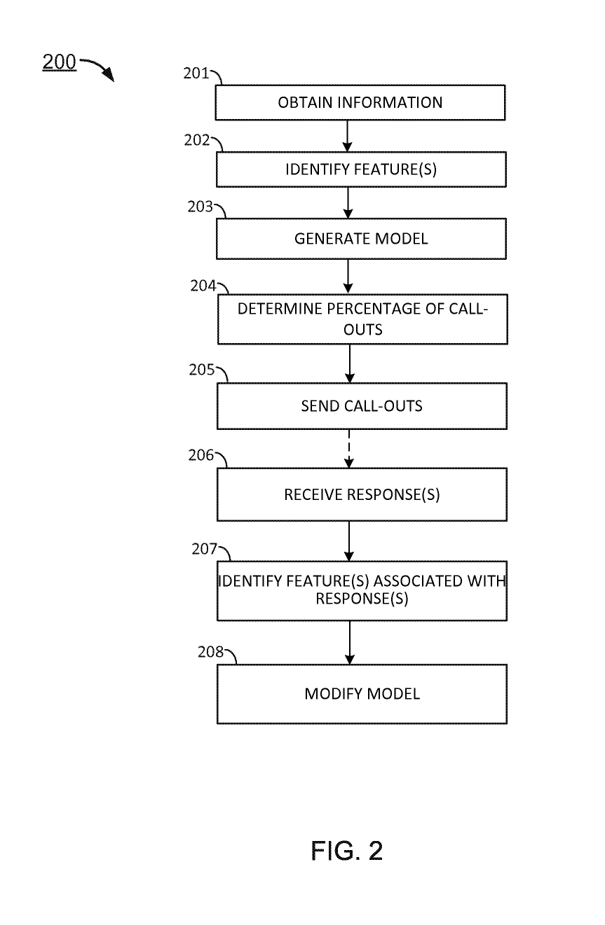

FIG. 2 is a flowchart showing an example process 200 that may be performed by content management system 110 including, at least partly, by prediction engine 142. Process 200 is described in the context of online advertising (“ads”); however, process 200 is applicable to determining whether to send a call-out for an auction involving any appropriate online content or other distributable content.

According to process 200, information is obtained (201) about call-outs from at least one bidder of an online content auction. In some implementations, the information may be obtained for, and process 200 applied to, a single bidder. In other implementations, the information may be obtained for, and process 200 applied to, multiple bidders having one or more attributes in common. For example, the multiple bidders may be advertisers that sell a similar product, that have similar bidding histories, that serve a similar demographic, and so forth. Any appropriate attribute may be used to group bidders for process 200. The obtained information spans, and is obtained for, a time period. In some implementations, the time period is one day (e.g., information about call-outs made in the previous day is obtained); however, in other implementations, the time period may be longer or shorter than a day. The obtained information may identify which call-outs, that were made within the time period (e.g., the previous day), did not result in a response.

The obtained information is used to identify (202) one or more features that are common to call-outs that did not result in at least a threshold number of responses from a bidder (this example assumes that the process is run for a single bidder). The threshold may be predefined, and may be a certain percentage of the total number of call-outs sent to the bidder. In some implementations, the threshold is one, meaning that the call-outs did not result in at least one response or in at least a threshold number of responses. In other implementations, the threshold may be greater than one. As noted above, examples of the one or more features that can be part of the information include, but are not limited to, one or more of the following: a country in which content for a call-out was to be presented, a geographic area in which the content was to be presented, a size of a slot in which the content was to be presented, a page on which the content was to be presented, a language of the page on which the content was to be presented, a type of device on which the content was to be presented, a media type of a slot in which the content was to be presented, information about a publisher (e.g., Web page owner) that was to present the content, a product category relating to a page in which the content was to be presented, a branding type associated with the content, and a network carrier over which the content was to be presented.

The feature(s) may be identified (202) using a machine learning process that iterates through individual features and/or combinations of features and determines, for each feature or combination, whether a response to a call-out associated with the feature or combination of features was received. The combinations may include two features or more than two features. In an example using two of the foregoing features, the machine-learning process may select a country (e.g., the United States) in which content for a call-out was to be presented and a geographic area (e.g., California) in which the content was to be presented. For each call-out to a bidder in a time period, such as the past day, the machine learning process determines whether that combination of features resulted in a response. If a response was not received more than a threshold number of times, then that combination of features is deemed not to be of interest to the bidder. This process may be iterated for individual features and over any appropriate combinations of features in order to determine which are not of interest to the bidder.

A model is generated (203) for the bidder that predicts whether the bidder will respond to a call-out associated with a feature or combination of features. For example, the model may specify that a bidder will respond to a call-out for a 5 cm by 5 cm slot, but will not respond to a call-out where the content is to be presented on a mobile device and the content is to be presented on a French language page.

In some example implementations, the model is generated (e.g., trained) on one or more servers that are within a specified geographic proximity of the bidder. For example, if a bidder is in California, servers on the west coast of the United States may be used to generate the model based on the previous day's call-out information, and store the model in memory. That model may then be propagated to servers outside the geographic proximity (e.g., servers outside the west coast of the United States) during routine server synchronization. So, in some implementations, servers that are “local” to a bidder store the most up-to-date model for predicting whether the bidder will respond to a call-out. In other implementations, this need not be the case, and the generated model may be propagated immediately to all servers that support the content management system.

The model is used to determine (204) a percentage of additional (e.g., future) call-outs associated with the identified features or combinations of features that are to be sent to the bidder. More specifically, the model predicts which call-outs will result in responses based on one or more features or combinations associated with those call-outs. In some implementations, the model specifies a percentage of such call-outs that are to be sent even though the model predicted that there would be no response. In some implementations, that percentage is zero, meaning that no call-outs of that type are sent. In other implementations, that percentage is non-zero. In cases where such call-outs are sent, the call-outs may be sent in order to detect a change in the bidder's strategy. For example, if it is later discovered that the bidder responds to a call-out associated with features or combinations that the model predicts will not result in a response, the model may be modified. This modification is described in more detail below.

In some implementations, a non-zero percentage of call-outs that are predicted by the model not to elicit a response are nevertheless sent (205) to the bidder. The bidder may react to those call-outs in the manner described above. That is, the bidder may either respond to a call-out with content and a bid, or the bidder may ignore the call-out. In this example, the model predicts that the bidder will ignore the call-out because the call-out is associated with one or more features that have been identified as not being of interest to the bidder. However, in some cases, the bidder may respond to a call-out. For example, the bidder may change their bidding strategy, resulting in a call-out response when none was predicted. In this case, the model may be modified to reflect this change in bidding strategy. That it is optional for a bidder to respond to a call-out is indicated graphically in FIG. 2 by the dashed line between operations 205 and 206.

By way of example, for the newly-sent (additional) call-outs, process 200 may obtain (206) information about the additional call-outs. The information identifies which additional call-outs resulted in at least one response. Using this information, one or more features are identified (207) that are common to the additional call-outs that resulted in at least one response. The feature, or combination of features, may be from among those described above. The model may be modified (208) to take into account that the feature or combination of features that are common to the additional call-outs resulted in at least one response. For example, that feature or combination of features may be removed from the model or not designated as features that do not elicit a response.

In some implementations, only the models in server(s) that are geographically local (e.g., within a region) to the bidder are modified initially. Models maintained outside the local geographic area not updated until new data is obtained about the bidder for the time period (e.g., they may not be updated until the next day). The modified model may be propagated to those servers to perform the updating. In some implementations, the same models are maintained among servers used in sending call-outs, and those models are updated immediately regardless of the geographic proximity of those servers to various bidders.

In some example implementations, the system described herein may choose not to send call-outs that have been ignored a certain percentage of times in the past (and not necessarily always ignored). For example, if the system predicts that a call-out has only a 10% chance of returning a bid, the system may choose not to send the call-out. This feature may benefit buyers that are quota-constrained (e.g., that cannot handle all call-outs) to receive only call-outs that have a good chance of returning a bid.

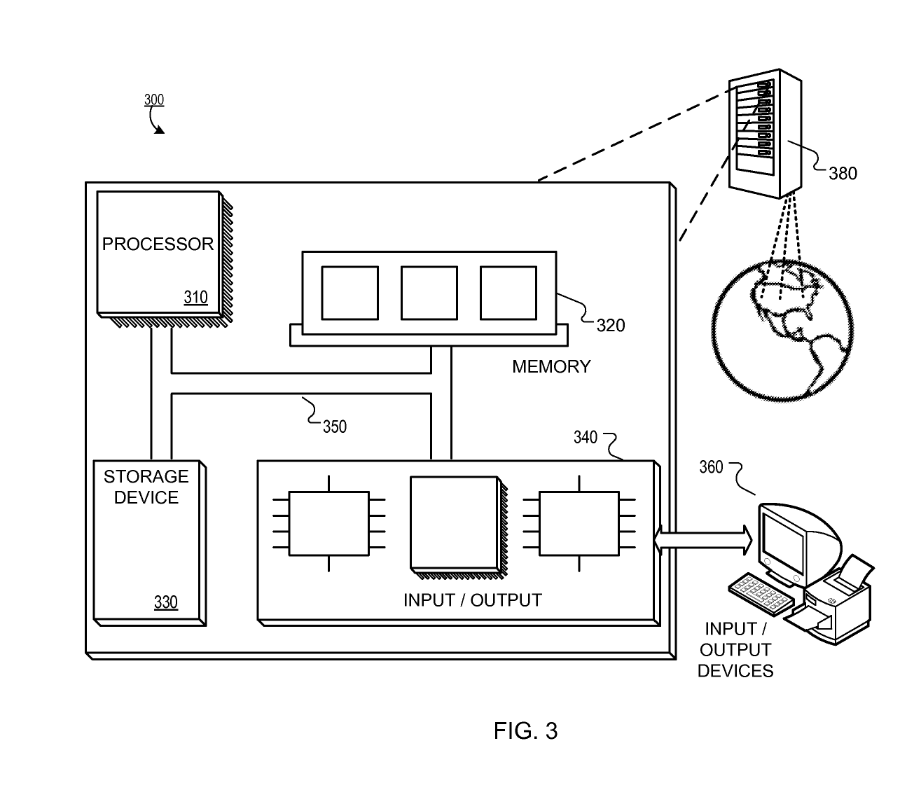

FIG. 3 is block diagram of an example computer system 300 that may be used in performing the processes described herein, including process 200 and its various modifications. The system 300 includes a processor 310, a memory 320, a storage device 330, and an input/output device 340. Each of the components 310, 320, 330, and 340 can be interconnected, for example, using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 can include, for example, a hard disk device, an optical disk device, or some other large capacity storage device.

The input/output device 340 provides input/output operations for the system 300. In one implementation, the input/output device 340 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 360.

The web server, advertisement server, and impression allocation module can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The web server and advertisement server can be distributively implemented over a network, such as a server farm, or can be implemented in a single computer device.

Example computer system 300 is depicted as a rack in a server 380 in this example. As shown the server may include multiple such racks. Various servers, which may act in concert to perform the processes described herein, may be at different geographic locations, as shown in the figure. The processes described herein may be implemented on such a server or on multiple such servers. As shown, the servers may be provided at a single location or located at various places throughout the globe. The servers may coordinate their operation in order to provide the capabilities to implement the processes.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

In this regard, various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Content, such as ads, may be displayed on a computer peripheral (e.g., a monitor) associated with a computer. The display physically transforms the computer peripheral. For example, if the computer peripheral is an LCD display, the orientations of liquid crystals are changed by the application of biasing voltages in a physical transformation that is visually apparent to the user. As another example, if the computer peripheral is a cathode ray tube (CRT), the state of a fluorescent screen is changed by the impact of electrons in a physical transformation that is also visually apparent. Moreover, the display of content on a computer peripheral is tied to a particular machine, namely, the computer peripheral.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Elements of different implementations described herein can be combined to form other implementations not specifically set forth above. Elements can be left out of the processes, computer programs, Web pages, etc. described herein without adversely affecting their operation. In addition, the logic flows depicted in the figures do not require the particular order shown, or sequential order, to achieve desirable results. Various separate elements can be combined into one or more individual elements to perform the functions described herein.

Other implementations not specifically described herein are also within the scope of the following claims.

What is claimed is:

1. A method performed by one or more processing devices, comprising:
obtaining information about call-outs from at least one bidder of an online content auction, the information spanning a time period and the information identifying which call-outs, within the time period, did not result in a response;
using the one or more processing devices to identify, based on the information, one or more features that are common to call-outs that did not result in at least a threshold number of responses from the at least one bidder;
generating, and storing in memory on at least one server, a model for the at least one bidder that predicts whether the at least one bidder will respond to a call-out associated with the one or more features;
using the model to determine a percentage of additional call-outs having the one or more features to send to the at least one bidder; and
sending the percentage of additional call-outs to the at least one bidder.

2. The method of claim 1, wherein the threshold number of responses is at least one response and wherein the percentage of additional call-outs is non-zero.

3. The method of claim 1, further comprising:
obtaining information about the additional call-outs, the information identifying which additional call-outs resulted in at least one response;
using the one or more processing devices to identify, based on the information about the additional call-outs, one or more features that are common to the additional call-outs that resulted in at least one response; and
modifying the model to take into account that the one or more features that are common to the additional call-outs resulted in at least one response.

4. The method of claim 3, wherein modifying the model comprises removing, from the model, the one or more features that are common to the additional call-outs that resulted in at least one response.

5. The method of claim 1, wherein the model is resident on multiple servers throughout a geographic area; and
wherein the at least one server is within a specified geographic proximity of the at least one bidder within the geographic area; and
wherein the method further comprises modifying the model stored in the at least one server and, after an elapse of the time period following the modifying, modifying models stored in others of the multiple servers.

6. The method of claim 1, wherein the at least one bidder is a single bidder.

7. The method of claim 1, wherein the at least one bidder comprises multiple bidders having one or more attributes in common.

8. The method of claim 1, wherein the one or more features comprises one or more of the following: a country in which content is to be presented, a geographic area in which content is to be presented, a size of a slot in which content is to be presented, a page on which content is to be presented, a language of the page on which content is to be presented, a type of device on which content is to be presented, a media type of a slot in which content is to be presented, information about a publisher that is to present the content, a product category relating to a page in which the content is to be presented, a branding type associated with the content, and a network carrier over which the content is to be presented.

9. The method of claim 1, wherein identifying the one or more features comprises examining the information for different combinations of the one or more features to identify which combinations of the one or more features correspond to call-outs that did not result in a threshold number of responses from the at least one bidder.

10. One or more machine-readable storage devices storing instructions that are executable by one or more processing devices to perform operations comprising:
obtaining information about call-outs from at least one bidder of an online content auction, the information spanning a time period and the information identifying which call-outs, within the time period, did not result in a response;
identifying, based on the information, one or more features that are common to call-outs that did not result in at least a threshold number of responses from the at least one bidder;
generating, and storing in memory on at least one server, a model for the at least one bidder that predicts whether the at least one bidder will respond to a call-out associated with the one or more features;
using the model to determine a percentage of additional call-outs having the one or more features to send to the at least one bidder; and
sending the percentage of additional call-outs to the at least one bidder.

11. The one or more machine-readable storage devices of claim 10, wherein the threshold number of responses is at least one response and wherein the percentage of additional call-outs is non-zero.

12. The one or more machine-readable storage devices of claim 10, wherein the operations comprise:
obtaining information about the additional call-outs, the information identifying which additional call-outs resulted in at least one response;
identifying, based on the information about the additional call-outs, one or more features that are common to the additional call-outs that resulted in at least one response; and
modifying the model to take into account that the one or more features that are common to the additional call-outs resulted in at least one response.

13. The method of claim 12, wherein modifying the model comprises removing, from the model, the one or more features that are common to the additional call-outs that resulted in at least one response.

14. The method of claim 10, wherein the model is resident on multiple servers throughout a geographic area; and
wherein the at least one server is within a specified geographic proximity of the at least one bidder within the geographic area; and
wherein the method further comprises modifying the model stored in the at least one server and, after an elapse of the time period following the modifying, modifying models stored in others of the multiple servers.

15. The method of claim 10, wherein the at least one bidder is a single bidder.

16. The method of claim 10, wherein the at least one bidder comprises multiple bidders having one or more attributes in common.

17. The method of claim 10, wherein the one or more features comprises one or more of the following: a country in which content is to be presented, a geographic area in which content is to be presented, a size of a slot in which content is to be presented, a page on which content is to be presented, a language of the page on which content is to be presented, a type of device on which content is to be presented, a media type of a slot in which content is to be presented, information about a publisher that is to present the content, a product category relating to a page in which the content is to be presented, a branding type associated with the content, and a network carrier over which the content is to be presented.

18. The method of claim 10, wherein identifying the one or more features comprises examining the information for different combinations of the one or more features to identify which combinations of the one or more features correspond to call-outs that did not result in a threshold number of responses from the at least one bidder.

19. A system comprising:
memory storing instructions that are executable; and
one or more processing devices to execute the instruction to perform operations comprising:
obtaining information about call-outs from at least one bidder of an online content auction, the information spanning a time period and the information identifying which call-outs, within the time period, did not result in a response;
identifying, based on the information, one or more features that are common to call-outs that did not result in at least a threshold number of responses from the at least one bidder;
generating, and storing in memory on at least one server, a model for the at least one bidder that predicts whether the at least one bidder will respond to a call-out associated with the one or more features;
using the model to determine a percentage of additional call-outs having the one or more features to send to the at least one bidder; and
sending the percentage of additional call-outs to the at least one bidder.

20. The system of claim 19, wherein the operations comprise:
obtaining information about the additional call-outs, the information identifying which additional call-outs resulted in at least one response;
identifying, based on the information about the additional call-outs, one or more features that are common to the additional call-outs that resulted in at least one response; and
modifying the model to take into account that the one or more features that are common to the additional call-outs resulted in at least one response.
